(19) United States
(12) Patent Application Publication
(10) Pub. No.: US 2026/0260229 A1
(43) Pub. Date: Sep. 3, 2026

(54) SECURELY AND EFFICIENTLY USING TOKENISED VCNS ON ELECTRONIC DEVICES, AND IN E-COMMERCE PLATFORMS

(71) Applicant: MASTERCARD INTERNATIONAL INCORPORATED, Purchase, NY (US)

(72) Inventors: James Christian NOË, West Wickham (GB); Thierry DELCROIX, London (GB); John TIERNEY, Wirral (GB)

(21) Appl. No.: 18/877,749

(22) PCT Filed: Apr. 24, 2023
(86) PCT No.: PCT/US2023/019576

§ 371 Date: Dec. 20, 2024

(30) Foreign Application Priority Data
Jun. 28, 2022 (GB) 2209451.0

(51) Int. Cl. G06Q 20/34; G06Q 20/38; G06Q 20/40

(52) U.S. Cl. CPC G06Q 20/351; G06Q 20/38215; G06Q 20/401; G06Q 20/405; G06Q 2220/00

(57) ABSTRACT

Broadly speaking, the present invention provides a technical solution by which virtual cards can be leveraged to become tokens generated by the payment platform and coupled with dynamic cryptography to enhance security, reliability, performances, user experience and reduce latency during the transactional flow. This technical solution advantageously ensures that transactions are simplified for implementation, while being efficient in terms of BIN and PAN usages, and having minimal latency, resulting in simpler integration and faster transactions. Additionally, the present invention requires relatively little change to the configuration of the computing devices that collectively function to enable the transaction to take place (e.g. payment network computing devices, merchant computing devices). Furthermore, the invention can improve the security around use of virtual cards as it enables a dynamic cryptogram to be used rather than a relatively insecure static cryptogram.

### CROSS REFERENCE TO RELATED APPLICATION

This application claims the benefit of United Kingdom Patent Application No. 2209451.0, which was filed on Jun. 28, 2022, the entire contents of which are hereby incorporated by reference for all purposes.

### FIELD OF INVENTION

This invention relates generally to the use of virtual cards and virtual card numbers on electronic devices and more particularly on an electronic commerce platform.

### BACKGROUND

Virtual card numbers are a convenient way to make debit/credit card purchases online. They allow you to shop online without giving merchant your actual card number. Thanks to virtual card numbers, the consumer can shop online faster and more securely. The virtual numbers are still linked to a debit/credit/prepaid card account, but they allow consumers to use a different number to fill out payment information when they shop online.

Security is increased while using a Virtual Card, because the actual debit/credit card is never provided to any websites wherever the consumer shops. If a risk of fraud has been found on any of these websites, the debit/credit card will never be compromised. For this type of card, consumers may opt to create them for a specific transaction, for a single use, for a specific time period, or keep the virtual card indefinitely, until such time as they wish to delete it.

Virtual cards can also be used by corporations. For example, a manager may want to send one of their team on a business trip, and provide them with a specific budget. The manager may issue a virtual card to the employee that has limited use (e.g. limited to travel merchants and hotels only), limited budget, and a limited timespan.

However, in certain payment platforms it is currently only possible to use virtual cards for certain types of e-commerce transactions (a.k.a. card not present transactions). It is not always viewed as technologically efficient to tokenize a Virtual Card Number, VCN, since this creates multiple representations of the underlying card number, and there may be challenges in ensuring the correct acceptance of the VCN's token in all of the relevant acceptance environments. As a result, dynamic cryptograms cannot be used for contactless and e-commerce transactions involving virtual cards.

Tokens, issued and maintained by a payment network service such as the ‘Mastercard Digital Enablement Service’ (MDES) provided by the assignee, are card numbers that mobile devices use in place of the card number printed on the physical card. As used herein, references to the Mastercard Digital Enablement Service (MDES), an example of a payment platform, are understood to refer to a collection of computer-implemented services that transform any connected device into a commerce device to make and receive payments. These tokens are not exposed to the end-users (only the last 4 digits are displayed on the graphic representation of the cards into the mobile payment wallet). Therefore, if an issuer wanted to utilise a service such as MDES with virtual cards, the consumer would potentially have multiple identifiers for different transaction types and a complex back-end solution would be needed. It would result in three different identifiers being used for a transaction: the token; the virtual card number; and the funding primary account number. This is complex to implement and adds significant latency to the transaction. It is furthermore inefficient, particularly in terms of bank identification number (BIN) and primary account number (PAN) usages, as well as cryptographic keys. Having three different identifiers in a transaction would have double mapping, which would require a large number of different PANs, BINs, and account ranges. Double mapping causes complications from an issuing and maintenance perspective and also adds significant latency to transactions. Particularly, the increased latency may be more visible during the processing phase of the transaction, when the data would have to be re-mapped twice-from the token to a virtual card number, and then from this virtual card number to the corresponding funding payment account number that is the entity actually funding the transaction. Alternatively, the MDES token would have to be exposed to the user in order to be entered for e-commerce on a merchant site, unless the merchant site has in-application transaction support. This is an issue because the back end MDES tokens should never been seen by the consumer for security reasons.

There is thus a need for techniques to implement virtual cards while using payment network services such as MDES.

### SUMMARY OF THE INVENTION

In a first aspect, the invention provides a computer-implemented method for enabling use of virtual cards in e-commerce transactions, the method performed by a tokenization server. The method comprising receiving, from a user device, a transaction request corresponding to a transaction with a merchant, generating a virtual card number, VCN, which corresponds to a virtual card, generating and storing a cryptogram specific to the transaction with the merchant, providing the VCN to the merchant, obtaining an underlying funding primary account number, FPAN, of the virtual card, retrieving the cryptogram, checking the validity of the cryptogram, and providing an indication to the merchant if the cryptogram is valid or not valid.

In one embodiment of the first aspect, providing the VCN to the merchant further comprises transmitting the VCN to an API which transmits the VCN to the merchant.

In one embodiment of the first aspect, providing the VCN to the merchant further comprises providing the VCN to the user device for display to a user who manually transfers the VCN to the merchant.

In one embodiment of the first aspect, obtaining an underlying funding primary account number, FPAN, of the virtual card further comprises receiving the FPAN of the virtual card from a virtual card management service.

In one embodiment of the first aspect, the virtual card management service retrieves the FPAN by querying a database with the VCN to return the FPAN.

In one embodiment of the first aspect, when the cryptogram is not valid, a response declining authorisation is provided to the merchant via an acquirer.

In one embodiment of the first aspect, when the cryptogram is valid, the cryptogram is provided to the merchant with a virtual card management service which performs further checks.

In one embodiment of the first aspect, the further checks comprise one or more of determining whether the transaction is within a pre-configured timeframe, the transaction is at an allowed merchant and/or merchant category, the transaction amount is within a specified range, the transaction is for a specific amount, the aggregate of spend with the virtual card is less than or equal to a specified amount, the aggregate spend with the virtual card by merchant and/or merchant category is within a specified amount, the spend and/or aggregate spend with the virtual card at a merchant/merchant category is within a specified amount and within a specified time period.

In one embodiment of the first aspect, it is determined whether the further checks result in the transaction being declined or allowed with an alert.

In one embodiment of the first aspect, the VCN is an alphanumeric string.

In one embodiment of the first aspect, checking the validity of the cryptogram further comprises one or more of, checking that a time of the cryptogram is valid, checking that a transaction amount and currency matches the amount and currency at the merchant, and checking a channel the cryptogram is being used for is correct.

In a second aspect, the invention provides a tokenization server configured to perform the method of the first aspect.

In a third aspect, the invention provides a computer-readable medium comprising instructions which, when executed by a processor, cause the processor to perform the method of the first aspect.

Broadly speaking, the present invention provides a technical solution by which virtual cards can act as tokens. Also the invention would allow the consumer to generate cryptograms for a given transaction by using their consumer facing application while using a service such as MDES. Consumer facing applications may be applications that directly interact with consumers and may be used by consumers to connect and engage with businesses (e.g., mobile applications or customer portals). This technical solution advantageously ensures that transactions are simplified for implementation, while being efficient in terms of BIN and PAN usages, and having minimal latency, resulting in simpler integration and faster transactions. Additionally, the present invention requires relatively little change to the configuration of the computing devices that collectively function to enable the transaction to take place (e.g. payment network computing devices, merchant computing devices). Furthermore, the invention can improve the security around use of virtual cards as it enables a dynamic cryptogram to be used rather than a relatively insecure static cryptogram. The present invention can also improve the user experience of the consumers using virtual card numbers (VCNs), if the merchants have integrated to a new API provided by MDES. The token and cryptogram, generated by MDES, could be directly passed on to the merchants for each transaction, minimizing efforts to consumers and eliminating errors caused by mis-keying, incorrect copying, or other such user input errors.

### BRIEF DESCRIPTION OF THE DRAWINGS

Embodiments of the present invention are described below, by way of example only, with reference to the accompanying drawings, in which:

FIG. 1 illustrates in schematic form a system suitable for implementing aspects of the invention;

FIG. 2 illustrates in schematic form a system suitable for implementing aspects of the invention; and

FIG. 3 is a flow diagram setting out the method performed by a tokenization server according to an embodiment.

### DETAILED DESCRIPTION

In the following description aspects of the invention are at times described in the context of electronic payments. It will be appreciated however that the invention has application in any context outside of electronic payments where the use of virtual cards is required. The invention thus should not be limited in this regard.

As used herein, the term “Virtual Card Number” (VCN) is an alphanumeric (typically a 13-19 digit card number) identifier which has a format which is identifiable by a card network such as those networks implemented by Mastercard for the purpose of switching and otherwise processing transactions that rely on such numbers to identify the party making (or receiving) a payment, but which is never associated with a specific physical payment instrument (such as by appearing on the face of a payment card or being encoded on a chip or magnetic stripe of such a card). For example, a virtual card number may be a primary account number (PAN) in which some of the digits are a bank identification number (BIN) (also called an issuer identification number, IIN) used by the card network to identify and route a transaction authorisation request to the issuer of the virtual card number.

VCN details may include any one or more of, for example, the card number, an expiry date, a Card Verification Code (CVC), cardholder name and address details, a purchase type, a transaction amount, a transaction type (Single or Multi use), currency, supplier details, email instructions and validity period details. Further details such as a sort-code number may be provided, or indeed fewer details may be provided.

Virtual card numbers are often used in situations in which a consumer may not trust a merchant, and wants a VCN that is only valid for one single transaction. Alternatively, the user of the VCN may have been provided it by their employer for a specific use, and may be for a limited set of merchants, merchant categories, or time period. VCNs can be limited-use or even single-use, which has significant benefits when it comes to control and security. Should the details of a VCN be misappropriated, the subsequent use of those details is mitigated or even prevented, e.g. by disabling or deleting the virtual card. Further restrictions can be placed on the use of VCNs. For example, where the VCN details include information relating to a supplier, the VCN may be restricted such that it may only be used with that particular supplier or class of suppliers. There may also be restrictions on the amount available to spend in any given transaction. Finally there may also be restrictions on how long the VCN is valid for (e.g. an employer may make it valid only for the duration of a planned business trip). Restrictions may instead be based on other components of the VCN details or combinations thereof.

A company may want to issue a VCN to an employee for a specific use and period of time (e.g. a business trip up to £4,000 valid from 14 June to 30 August, only valid in hotels, airlines, taxis etc . . . ). VCNs currently can only easily be used online (e.g. typed into an e-commerce site), but the use in face-to-face (e.g. hotels, taxis etc . . . ) is challenging. A payment platform like MDES could solve this by creating a token on a device, however the payment platform cannot create a token that can be used in ‘traditional’ e-commerce-as the payment platform token must not be shown to the user, but the user needs the token PAN (e.g. VCN) to make the transaction.

As used herein, references to a virtual card management system (such as the Mastercard Purchase Control™ system/Mastercard inControl™ system) are understood to refer to VCN-based payment systems. A well-known example of a VCN-based commercial payment system is the Mastercard Purchase Control™ system/Mastercard inControl™ system. Web-based systems such as these enable organisations to provide their employees with limited-use VCNs with which transactions can be performed, instead of providing employees with physical purchasing cards. This improves the control, efficiency, compliance and security of transactions.

An organisation utilising a VCN-based payment system can create unique rules for each employee using the system. For example, an administrator may provide a custom set of rules for each employee. Alternatively, a blanket set of rules for the whole organisation may be created. Should one or more of the transaction parameters exceed the limits of the relevant pre-defined rules, the transaction request may either be automatically rejected or the request may be held while an administrator is notified. The administrator can then as a secondary input perform a manual analysis of the transaction request and either reject or approve the transaction request.

As used herein, references to a payment platform (such as the Mastercard Digital Enablement Service (MDES) platform) are understood to refer to a collection of computer-implemented services that transform any connected device into a commerce device to make and receive payments. The platform helps power user devices to enable secure payments to take place for contactless, e-commerce, and in-app payments. The platform validates a transaction, maps from the token back to the PAN and forwards it to the issuer for authorization. The MDES platform as described herein may additionally or alternatively be a token vault or tokenization platform.

As used herein, the Funding Primary Account Number (FPAN) means the primary account number of a payment account that is to be used to supply funds to pay for a transaction. The FPAN may appear on a physical card (or similar device). The FPAN may also be referred to as a real card number (RCN), which may be the same as the PAN described above. The RCN is the term that is typically used when referring to VCN platforms, and the FPAN is the term that is typically used when referring to tokenization platforms, however they both refer to the underlying PAN that is to be used for the purchase.

As used herein, authentication refers to the process by which a user is able to prove that they are who they purport to be. Typically, the user provides more than one of something they know (e.g. a PIN or passcode), and/or something they are (e.g. biometric information) and/or something they have (e.g. a smart card) in order to prove that they are who they purport to be and hence authenticate themselves with a party requesting the authentication.

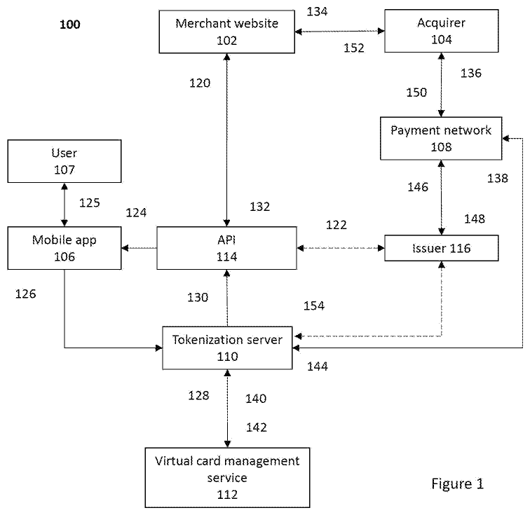

FIG. 1 shows a block diagram of a system 100 suitable for implementing embodiments of the invention. System 100 includes a merchant website 102 that is communicatively coupled 120 to an application programming interface (API) 114, e.g. via a public network such as the internet, or a private network or virtual private network, or combination thereof. Here, ‘communicatively coupled’ in the context of an API means that the relevant components which support the API can hence communicate with one another via the API. The merchant website 102 may be an e-commerce website. The API 114 is also communicatively coupled 122 with an issuer computer 116. Alternatively (and not shown), another third party directory service may help facilitate this lookup. The API 114 is further communicatively coupled 124 to a mobile application 106 (e.g., a consumer facing application, a customer portal, etc.) on a user device (e.g., a smartphone, laptop, desktop computer, tablet, gaming console, smart TV, wearable, etc.). A user 107 of the user device communicates 125 with the mobile application 106 via the user device. The user 107 of the user device is a consumer. The mobile application 106 on the user device is further communicatively coupled 126 with a tokenization server 110 (e.g. a tokenization service provided by the MDES platform), which itself communicates 128, 140, 142 with a virtual card management service 112 (e.g. the InControl™ service as provided by the applicant). The tokenization server 110 is further communicatively coupled 130 with the API 114. The API 114 is communicatively coupled 132 with the merchant website 102. The merchant website 102 further communicates 134, 152 with an acquirer 104, which itself communicates 136, 150 with a payment network 108. The payment network 108 is communicatively coupled 138, 144 with the tokenization server 110 and communicative coupled 146, 148 with the issuer 116 and the issuer 116 optionally communicates 154 with the tokenization server.

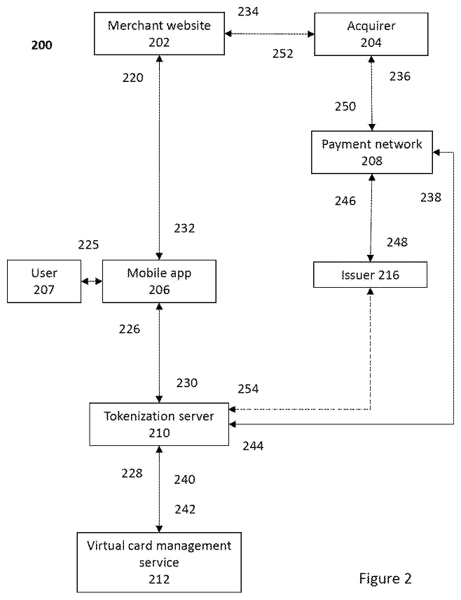

FIG. 2 shows a block diagram of another system 200 suitable for implementing embodiments of the invention. System 200 includes a merchant website 202 that is communicatively coupled 220, 232, e.g. via a public network such as the internet, or a private network or virtual private network, or combination thereof, to a mobile application 206 (e.g., a consumer facing application, a customer portal, etc.) on a user device (e.g., a smartphone, laptop, desktop computer, tablet, gaming console, smart TV, wearable, etc.). The merchant website 202 may be an e-commerce website. A user 207 of the user device communicates 225 with the mobile application 206 via the user device. The user 207 of the user device is a consumer. The mobile application 206 on the user device is further communicatively coupled 226, 230 with a tokenization server 210 (e.g. a security service provided by the MDES platform), which itself communicates 228, 240, 242 with virtual card management service 212 (e.g. the InControl™ service as provided by the applicant). The merchant site 202 further communicates 234, 252 with an acquirer 204, which itself communicates 236, 250 with a payment network 208. The payment network 208 is communicatively coupled 238, 244 with the tokenization server 210 and communicatively coupled 246, 248 with the issuer 216 and the issuer 216 communicates 254 with the tokenization server.

In FIG. 1, the merchant website 102 is integrated with the API 114. Whereas in FIG. 2, the merchant site 202 is not integrated with an API. While both system 100 and 200 can be used to implement the invention, system 100 offers some advantages relative to system 200. Having the merchant website 102 integrated with the API 114, as in system 100, improves transaction efficiency and speed and user experience when compared with the configuration of system 200. Furthermore, the use of the API 114 allows the merchant website 102 and the mobile application to hide the VCN token and pass a cryptogram through the API 114, improving security.

It will be appreciated that while only one merchant website 102, 202 is shown in FIG. 1 and FIG. 2, it is not necessary for the user 107, 207 to make use of the same merchant website 102, 202 for each transaction. A user 107, 207 of a user device is the consumer. In some cases the consumer is a legal person e.g. a service-providing corporation, rather than a natural person; in such cases, the merchant website 102, 202 can be a computer operated by, or on behalf of, the corporation. The consumer can be the corporation themselves, e.g. a merchant providing a good or service.

In the embodiment in which the merchant website 102 is integrated with the API 114, the process for making a payment using a VCN can be as follows. Description of user experience

First the user selects items on a merchant website 102 to buy and proceeds to the checkout on the merchant website 102. The user may select the option of paying with their banking mobile application.

The merchant website 102 displays the transaction amount to the user. The merchant website 102 may additionally display the transaction currency, shipping details, taxes, and other standard checkout items to the user.

The merchant website 102 gives the user the option to use a virtual card. For example, this may be a button, a new branded program, a specific checkout option or some other way to clearly guide the consumer to the right checkout experience.

An API 114 performs a re-direct or push of the transaction details, such as the merchant name, transaction amount and transaction currency, to the mobile application 106.

Optionally, a call is made to the issuer 116 to route the re-direct or push of the transaction details to the correct mobile application 106. Alternatively, a lookup service may help route the user to the right application.

The user opens the mobile application 106 and authenticates themselves to the mobile application. Alternatively, the user may already be authenticated on the mobile application.

Assuming the authentication is successful, the transaction details are re-directed or pushed from the merchant website 102 to the mobile application 106 by the API 114. The user confirms that the transactions details are correct. Particularly, that the merchant and the amount in the mobile application 106 match that of the merchant website 102 and the amount at the checkout on the merchant website 102. The user selects the virtual card to be used for payment from a list of possible virtual cards. There may be no physical card associated with the virtual card. There may be multiple virtual cards associated with a single payment account. The virtual card may be single use. The virtual card may be issued to a user as an employee of a company. The virtual card may be restricted in the payments made with it, for example, time limit restrictions, monetary limit restrictions, number of uses restrictions, and/or merchant restrictions.

Alternatively, if a VCN already exists (e.g. from a prior transaction made with the mobile application 106), the transaction details are automatically pre-entered in the mobile application 106. The user validates the pre-entered transaction details and selects the VCN which has already been generated by the tokenization server 110.

Optionally, the user device generates a cryptogram specific to the transaction in the mobile application 106. The cryptogram specific to the transaction generated by the user device in the mobile application 106 is sent to the tokenization server 110 at step 308 for processing and/or validation, as detailed below. This is a dynamic cryptogram that changes for each transaction, for each VCN, for each transaction amount etc. This means that the cryptogram is valid for use only with a single transaction, improving security by preventing attacks such as replay attacks.

The tokenization server 110 then proceeds to carry out step 302, as detailed below.

In the embodiment in which the merchant website 202 is not integrated with an API 114, the process for making a payment using a VCN can be as follows.

First the user selects items on a merchant website 202 to buy and proceeds to the checkout on the merchant website 202.

The merchant website 202 displays the transaction amount to the user. The merchant website 202 may additionally display the transaction currency, shipping details, taxes, and other standard checkout items to the user.

The merchant website 202 gives the user the option to use a virtual card. For example, this may be a button, a new branded program, a specific checkout option or some other way to clearly guide the consumer to the right checkout experience. Alternatively, the merchant website 202 is not changed from a standard checkout experience and the user checks out as normal, but uses their virtual card as describe below.

The user opens the mobile application 206 and authenticates themselves to the mobile application. Alternatively, the user may already be authenticated on the mobile application.

Assuming authentication is successful, the user selects the virtual card to be used for payment on the mobile application 206 from a list of possible virtual cards. There may be no physical card associated with the virtual card. There may be multiple virtual cards associated with a single payment account. The virtual card may be single use. The virtual card may be issued to a user as an employee of a company. The virtual card may be restricted in the payments made with it, for example, time limit restrictions, monetary limit restrictions, number of uses restrictions, and/or merchant restrictions. The user enters the transaction amount and currency from the merchant website 202 into the mobile application 206. Optionally, the user also enters the merchant website 202 details into the mobile application 206.

The user confirms that the merchant and the transaction amount and currency in the mobile application 206 match that of the merchant website 202 and the amount and currency at the checkout on the merchant website 202.

Optionally, the user device generates a cryptogram specific to the transaction in the mobile application 206. The cryptogram specific to the transaction generated by the user device in the mobile application 206 is sent to the tokenization server 210 at step 308 for processing and/or validation, as detailed below. This is a dynamic cryptogram that changes each transaction. This means that the cryptogram is valid for use only with a single transaction, improving security by preventing attacks such as replay attacks. Alternatively, the tokenization server 210 may generate the cryptogram, and store it for later validation.

The tokenization server 210 then proceeds to carry out step 302, as detailed below.

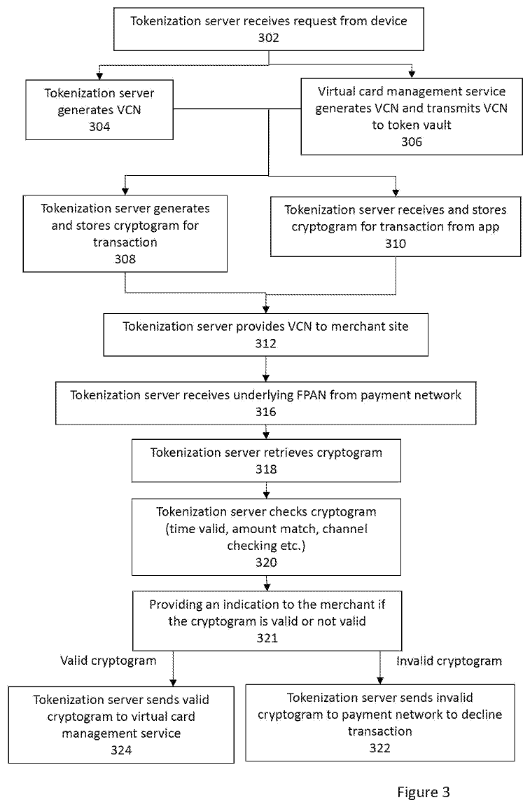

FIG. 3 sets out a method for use of VCNs in e-commerce transactions. The method of FIG. 3 can be performed by a tokenization server 110, 210 such as the Mastercard Digital Enablement Service (MDES).

In step 302, the tokenization server 110, 210 receives a transaction request corresponding to the transaction with the merchant website 102, 202 from the mobile application 106, 206 on the user device as discussed above.

In step 304, the tokenization server 110, 210 generates a virtual card number (VCN) which corresponds to a virtual card selected to be used for payment and has no correspondence to any physical payment instrument. The use of this VCN makes merchant integration easier and it is possible to use this VCN in e-commerce transactions, transactions using mobile-device wallets, etc.

Alternatively to step 304, in step 306 the virtual card management service 112, 212 generates a virtual card number (VCN) and transmits it to the tokenization server 110, 210. Currently, VCNs are usually generated by the payment network owning the BINs of the FPAN. By having the tokenization server 110, 210 or the virtual card management service 112, 212 generate the VCN, the need to use three different identifiers (a token, a virtual card number and a funding primary account number) during a transaction is removed. Instead, only the VCN and the FPAN/RCN are used, as the VCN acts as in place of a token. This is more efficient, simpler to implement and reduces latency of the transaction, resulting in simpler integration and faster transactions, as well as increased security. Furthermore, back end tokens (e.g. MDES tokens) cannot be exposed to a user, so unlike the present VCN, cannot be entered into a merchant site for an e-commerce transaction. The mapping of the VCN to the actual account number may be known to the tokenization server which operates a token vault securely storing the mapping, the merchant, and the acquirer. The issuer may build up a mapping of VCNs and/or tokens to FPANs through notification of the token and FPAN in an authorisation request. The VCN may have the same format as the actual account number, and thus be recognised by the payment network as an account identifier that can be used in a transaction.

Optionally, once the tokenization process is complete, the tokenization server 110, 210 sends the issuer 116, 216 a notification network message that the tokenization process has been completed. If the issuer opted in to receive this network message, this completes the tokenization process.

In step 308, the tokenization server 110, 210 generates a cryptogram specific to the transaction with the merchant website 102, 202 and then stores the generated cryptogram for processing and/or validation. Alternatively to step 308, in step 310 a cryptogram specific to the transaction is received by the tokenization server 110, 210 from the mobile application 106, 206 and stored by the tokenization server 110, 210 for processing and/or validation. This cryptogram is generated by the mobile application 106 on the user device. This adds extra security to the transaction, as the same entity is not both generating the cryptogram and verifying the transaction. In either case above the cryptogram is dynamic as it changes from transaction to transaction, improving the security around use of virtual cards.

In step 312, the tokenization server 110, 210 provides the VCN to the merchant website 102, 202.

In the embodiment in which the merchant website 102 is integrated with the API 114, the tokenization server 110 can provide the VCN to the merchant website 102 via the API 114, for future use. The merchant website 102 receives the VCN details. No information has to be entered into the merchant website 102 manually.

In the embodiment in which the merchant site 202 is not integrated with an API 114, the tokenization server 210 can provide the VCN to the merchant website 202, for future use, by providing the VCN to the user via the mobile application 206. The VCN is displayed to the user in the mobile application 206. The user manually enters the VCN details displayed on the mobile application 206 onto the merchant site 202 checkout page. Alternatively, the user may transfer the VCN details displayed on the mobile application 206 onto the merchant site 202 checkout page via NFC Mobile to Mobile, Mobile to Terminal, using 3D Bar Codes, Bluetooth, Bluetooth Low Energy, copy and paste, manual key entry, or any other transfer method.

The merchant website 102, 202 generates a transaction request and transmits the transaction request to the acquirer 104, 204. The transaction request may include details such as the VCN, the checkout amount, and the merchant details. In the embodiment in which the merchant website 102 is integrated with the API 114, the transaction request may further include the cryptogram. The acquirer 104, 204 receives the transaction request and generates an authorisation request. The payment network 108, 208 processes the authorisation request as part of the authorisation process and forwards it on to the tokenization server 110, 210. The tokenization server 110, 210 looks up the underlying funding primary account number (FPAN) of the virtual card from the authorisation request.

In step 316, the tokenization server 110, 210 obtains the underlying funding primary account number (FPAN) of the virtual card from the payment network 108. Optionally, the tokenization server 110, 210 may obtain the FPAN from the virtual card management service 112, 212, e.g. by the virtual card management service using the VCN to look it up in a database.

In step 318, the stored cryptogram specific to the transaction is retrieved by the tokenization server 110, 210.

In step 320, the validity of the retrieved cryptogram is checked. The validity checks may include one or more of checking that the time of the cryptogram is valid (as the cryptogram may only be valid for a limited time to help prevent fraud), checking that the transaction amount and the amount at the checkout on the merchant site checkout match, checking the transaction currency and the currency at the checkout on the merchant site checkout match, and checking the channel the cryptogram is being used for is correct (as the cryptogram may only be valid for a certain channel, for example, e-commerce, CVC2, etc.). The retrieved cryptogram may have been generated by the tokenization server 110, 210. In this embodiment, the cryptogram may use symmetric cryptography, as the cryptogram was generated by the tokenization server 110, 210 and eventually ends back at the tokenization server 110, 210 for validation.

In another embodiment, a digital signature may be used instead of, or in addition to, a cryptogram. The digital signature may use asymmetric cryptography and may be used instead or as well as a cryptogram using symmetric cryptography. The use of asymmetric cryptography has the benefit for the merchant site being able to verify the cryptogram has been sent by the tokenization server 110, 210, and if not, stop the transaction. This reduces the steps needed in the process. Any entity which has the right Payment System public key could validate that the signature is genuine, giving confidence about the transaction. The digital signature could end up back at the tokenization server 110, 210, to ensure that it has not been tampered with. Alternatively, it could contain a symmetric cryptogram, such as 8-byte MAC, that would be extracted and sent back in the authorisation request for validation.

As a result of the validity check of step 320, in step 321 an indication may be provided to the merchant website 102, 202 detailing if the cryptogram is valid or not valid. The indication may detail that the cryptogram is valid if all of the one or more validity checks completed in step 320 are valid. For example, the time of the cryptogram is valid, the transaction amount and the amount at the checkout on the merchant site checkout match, the transaction currency and the currency at the checkout on the merchant site checkout match, and/or the channel the cryptogram is being used for is correct. The indication may detail that the cryptogram is not valid is any of the one or more validity checks completed in step 320 are not valid. For example, if any one of the time of the cryptogram is not valid, the transaction amount and the amount at the checkout on the merchant site checkout do not match, the transaction currency and the currency at the checkout on the merchant site checkout do not match, and/or the channel the cryptogram is being used for is not correct. The merchant website 102, 202 may process the indication and display an approve or decline response to the user, depending on the validity of the cryptogram.

Alternatively or additionally to step 321, if, as a result of step 320, it is decided that the cryptogram is valid the method may proceed to step 324. In step 324, the tokenization server 110, 210 sends the valid cryptogram to virtual card management service 112, 212 to perform one or more further checks on the virtual card used for the transaction, such as whether the virtual card is being used within any pre-configured timeframe, whether the transaction is at an allowed merchant and/or merchant category, whether the transaction amount is within a specified range, whether the transaction is for a specific amount, whether the aggregate of spend is less than or equal to a specified amount, whether the aggregate spend by merchant and/or merchant category is within a specified amount, whether the spend and/or aggregate spend at a merchant/merchant category is within a specified amount and within a specified time period (e.g. no more than £100 on clothing in a calendar month), whether these, or any other configured rules are a hard rule (which would typically generate a decline) or a soft rule (which may allow the transaction but trigger an alert). Further checks on the virtual card used for the transaction are not limited to just the above and other further checks may be required depending on the situation.

Alternatively or additionally to step 321, if, as a result of step 320, it is decided that the cryptogram is not valid, the tokenization server 110, 210 may decline the transaction or pass the information on to the issuer 116, 216 that the cryptogram is not valid, so that the issue 116, 216 may make their down authorization decision. Alternatively if, as a result of step 320, it is decided that the cryptogram is not valid the method may proceed to step 322. In step 322, the tokenization server 110, 210 sends the invalid cryptogram to a payment network 108, 208, which returns a declined authorisation response to an acquirer. When step 322 is completed the following steps may follow.

The acquirer 104, 204 receives the decline authorisation response from the payment network 108, 208. The acquirer 104, 204 sends a response to the merchant website 102, 202. The merchant website 102, 202 processes the response and displays a decline response to the user.

As set out above, in step 324 the tokenization server 110, 210 sends the valid cryptogram to virtual card management service 112, 212 to perform the further checks discussed above. When step 324 is completed, the following steps may follow.

If the further checks performed by virtual card management service 112, 212 result in an invalid result, the virtual card management service 112, 212 sends the invalid cryptogram to the payment network 108, 208, which returns a declined authorisation response and sends the declined authorisation response to an acquirer 104, 204.

The acquirer 104, 204 receives the authorisation response from the payment network 108, 208. The acquirer 104, 204 sends a response to the merchant website 102, 202. The merchant website 102, 202 processes the response and displays a decline response to the user.

If the further checks performed by virtual card management service 112, 212 result in a valid result, the virtual card management service 112, 212 sends the valid cryptogram to the payment network 108, 208, which updates the authorisation request as needed, e.g. with On-Behalf of Services (OBS) results.

The payment network 108, 208 performs any other core processing needed. Other core processing needed may include validating that all mandatory data elements in the request are present and/or validating that all data elements that are present are correctly formatted, regardless of whether they are mandatory, conditional, or optional data elements. The payment network 108, 208 sends an updated authorisation request to the issuer 116, 216 for authorisation. The issuer 116, 216 processes the authorisation request. The issuer 116, 216 creates and sends an authorisation response to the payment network 108, 208. The payment network 108, 208 receives the authorisation response and sends it to the acquirer 104, 204.

The acquirer 104, 204 receives the authorisation response from the payment network 108, 208. The acquirer 104, 204 sends a response to the merchant website 102, 202. The merchant website 102, 202 processes the response and displays an approve response to the user.

It will be appreciated that the processes set out above enable merchant integration to be made easier. These processes also enable a virtual card to have a dynamic cryptogram, further enhancing security.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

It will be appreciated that the processes described above can be implemented using a computer. Here, ‘computer’ is understood in the broad sense to refer to any collection of processing resources capable of operating on digital data. This includes traditional physical computers such as laptops, desktop computers, tablets, mobile phones, etc. and also virtual computers such as cloud-based virtual machines, servers, server clusters, and the like.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, any one or more steps of the methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and non-volatile media, and removable and non-removable media such as a firmware, physical and virtual storage, SD cards, memory chips and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is enabling the use of VCNs with systems such as a payment platform like MDES. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

1. A computer-implemented method for enabling use of virtual cards in e-commerce transactions, the method performed by a tokenization server, the method comprising:
receiving, from a user device, a transaction request corresponding to a transaction with a merchant;
generating a virtual card number, VCN, which corresponds to a virtual card;
generating and storing a cryptogram specific to the transaction with the merchant;
providing the VCN to the merchant;
obtaining an underlying funding primary account number, FPAN, of the virtual card;
retrieving the cryptogram;
checking the validity of the cryptogram; and
providing an indication to the merchant if the cryptogram is valid or not valid.

2. The computer-implemented method of claim 1, wherein providing the VCN to the merchant further comprises:
transmitting the VCN to an API which transmits the VCN to the merchant.

3. The computer-implemented method of claim 1, wherein providing the VCN to the merchant further comprises:
providing the VCN to the user device for display to a user who manually transfers the VCN to the merchant.

4. The computer-implemented method of claim 1, wherein obtaining an underlying funding primary account number, FPAN, of the virtual card further comprises:
receiving the FPAN of the virtual card from a virtual card management service.

5. The computer-implemented method of claim 4, wherein the virtual card management service retrieves the FPAN by querying a database with the VCN to return the FPAN.

6. The computer-implemented method of claim 1, wherein when the cryptogram is not valid, a response declining authorisation is provided to the merchant via an acquirer.

7. The computer-implemented method of claim 1, wherein when the cryptogram is valid, the cryptogram is provided to the merchant with a virtual card management service which performs further checks.

8. The computer-implemented method of claim 7, wherein the further checks comprise one or more of determining whether:
the transaction is within a pre-configured timeframe;
the transaction is at an allowed merchant and/or merchant category;
a transaction amount is within a specified range;
the transaction is for a specific amount;
an aggregate of spend with the virtual card is less than or equal to a specified amount;
the aggregate of spend with the virtual card by merchant and/or merchant category is within a specified amount;
the spend and/or aggregate spend with the virtual card at a merchant/merchant category is within a specified amount and within a specified time period.

9. The computer-implemented method of claim 8, wherein it is determined whether the further checks result in the transaction being declined or allowed with an alert.

10. The computer-implemented method of claim 1, wherein the VCN is an alphanumeric string.

11. The computer-implemented method of claim 1, wherein checking the validity of the cryptogram further comprises one or more of:
checking that a time of the cryptogram is valid;
checking that a transaction amount and currency matches an amount and currency at the merchant; and
checking a channel the cryptogram is being used for is correct.

12. A tokenization server configured to perform a method comprising:
receiving, from a user device, a transaction request corresponding to a transaction with a merchant;
generating a virtual card number, VCN, which corresponds to a virtual card;
generating and storing a cryptogram specific to the transaction with the merchant;
providing the VCN to the merchant;
obtaining an underlying funding primary account number, FPAN, of the virtual card;
retrieving the cryptogram;
checking the validity of the cryptogram; and
providing an indication to the merchant if the cryptogram is valid or not valid.

13. A computer-readable medium comprising instructions which, when executed by a processor cause the processor to perform a method comprising:
receiving, from a user device, a transaction request corresponding to a transaction with a merchant;
generating a virtual card number, VCN, which corresponds to a virtual card;
generating and storing a cryptogram specific to the transaction with the merchant;
providing the VCN to the merchant;
obtaining an underlying funding primary account number, FPAN, of the virtual card;
retrieving the cryptogram;
checking the validity of the cryptogram; and
providing an indication to the merchant if the cryptogram is valid or not valid.
